(19) United States
(12) Patent Application Publication
(10) Pub. No.: US 2020/0271202 A1
(43) Pub. Date: Aug. 27, 2020

(54) ROTOR OF INNER ROTOR TYPE MOTOR

(71) Applicant: SHINANO KENSHI CO., LTD., Ueda-shi (JP)

(72) Inventors: Hironori NAKAJIMA, Nagano (JP); Keita MORISAKI, Nagano (JP)

(73) Assignee: SHINANO KENSHI CO., LTD., Ueda-shi (JP)

(21) Appl. No.: 16/722,624

(22) Filed: Dec. 20, 2019

(30) Foreign Application Priority Data
Feb. 27, 2019 (JP) 2019-034209

(51) Int. Cl. F16H 21/18

(52) U.S. Cl. CPC F16H 21/18

(57) ABSTRACT

A rotor of an inner rotor type motor includes: a circular plate portion rotatably supported about an axis; an eccentric portion provided in the circular plate portion and eccentric with respect to the axis; a peripheral wall portion extending from an outer edge of the circular plate portion; and a permanent magnet held on the peripheral wall portion, wherein a circular plate portion includes a hole portion located radially outward from the eccentric portion, and the peripheral wall portion includes a protruding portion protruding radially inward and being located in a side opposite to the hole portion with respect to the eccentric portion.

### CROSS-REFERENCE TO RELATED APPLICATION

This application is based upon and claims the benefit of priority of the prior Japanese Patent Application No. 2019-034209, filed on Feb. 27, 2019, the entire contents of which are incorporated herein by reference.

### BACKGROUND

### (i) Technical Field

The present disclosure relates to a rotor of an inner rotor type motor.

### (ii) Related Art

Conventionally, there is known a compressor that reciprocally moves a member such as a piston by rotational power of a motor. Unbalance in weight occurs in such an apparatus due to its structure. In order to eliminate the unbalance, for example, Japanese Unexamined Patent Application Publication No. 2017-75589 describes that a balance weight is provided in a rotor.

### SUMMARY

According to an aspect of the present disclosure, there is provided a rotor of an inner rotor type motor including: a circular plate portion rotatably supported about an axis; an eccentric portion provided in the circular plate portion and eccentric with respect to the axis; a peripheral wall portion extending from an outer edge of the circular plate portion; and a permanent magnet held on the peripheral wall portion, wherein a circular plate portion includes a hole portion located radially outward from the eccentric portion, and the peripheral wall portion includes a protruding portion protruding radially inward and being located in a side opposite to the hole portion with respect to the eccentric portion.

### BRIEF DESCRIPTION OF THE DRAWINGS

FIG. 1 is a front view of a rotor ;

FIG. 2 is a cross-sectional view taken along line A-A of FIG. 1;

FIG. 3 is a rear view of the rotor; and

FIG. 4 is a perspective view of the rotor.

### DETAILED DESCRIPTION

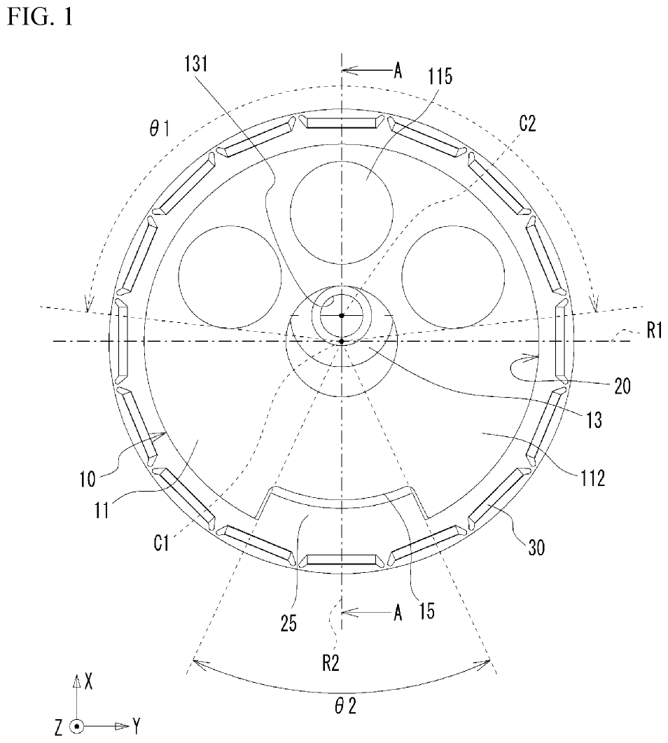

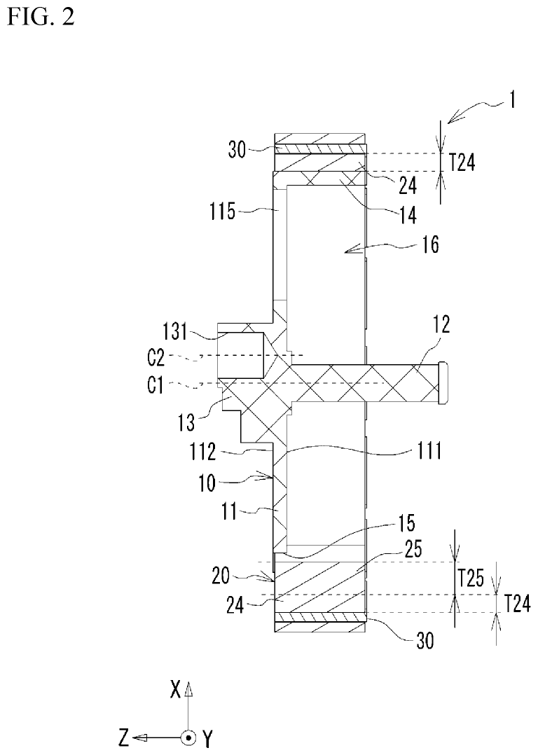

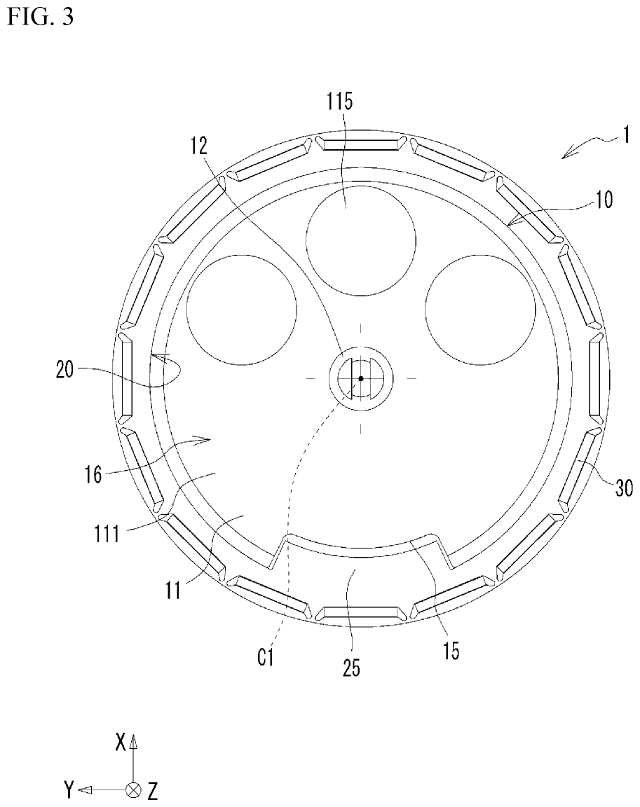

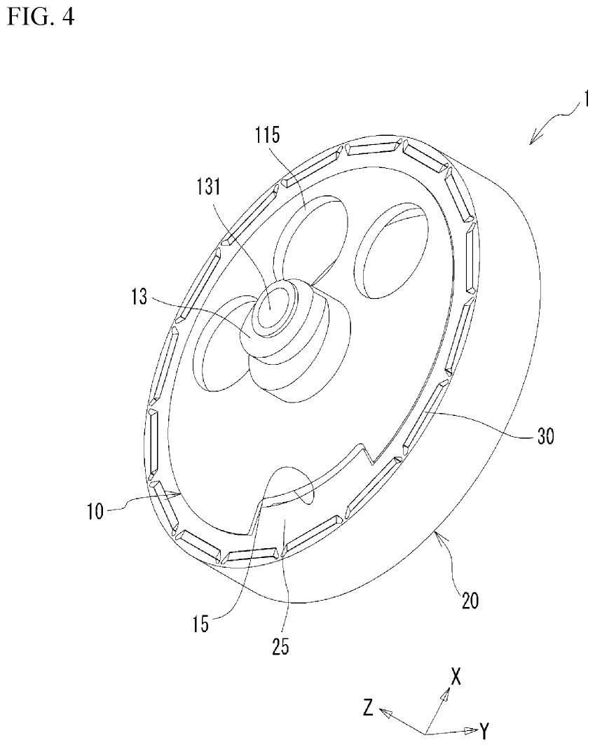

FIG. 1 is a front view of a rotor 1. FIG. 2 is a cross-sectional view taken along line A-A of FIG. 1. FIG. 3 is a rear view of the rotor 1. FIG. 4 is a perspective view of the rotor 1. FIGS. 1 to 4 illustrate an X axis, a Y axis, and a Z axis orthogonal to one another. The rotor 1 is used in an inner rotor type motor. The rotor 1 includes a first member 10, a second member 20, and permanent magnets 30.

First, the first member 10 will be described. The first member 10 includes a circular plate portion 11, a rotational shaft portion 12, an eccentric portion 13, and an inner peripheral wall portion 14, which are integrally formed and are made of the same material, specifically aluminum. As illustrated in FIGS. 1 and 3, the circular plate portion 11 has a substantially circular shape when viewed in the Z direction. The circular plate portion 11 includes a lower surface 111 and an upper surface 112 opposite to the lower surface 111. As will be described in detail later, hole portions 115 are formed in the circular plate portion 11.

The rotational shaft portion 12 extends from the lower surface 111 in the −Z direction perpendicular to the lower surface 111. The rotational shaft portion 12 supports entirely the rotor 1 for rotation about a rotation axis C1. The eccentric portion 13 protrudes from the upper surface 112 in the +Z direction, and is provided with an attachment hole portion 131 having a bottom. An eccentric axis C2 of the attachment hole portion 131 is eccentric away from the rotation axis C1 in the +X direction. A driven object (not illustrated), for example, a member such as a piston that reciprocates in a radial direction by the rotation of the rotor 1 is attached to the attachment hole portion 131. When the rotational shaft portion 12 rotates about the rotation axis C1, the eccentric axis C2 of the attachment hole portion 131 swings around the rotation axis C1. Thus, the piston or the like attached to the attachment hole portion 131 reciprocates in a predetermined direction.

The inner peripheral wall portion 14 extends from an outer peripheral edge of the circular plate portion 11 in the −Z direction, and has a substantially cylindrical shape. A height of the inner peripheral wall portion 14 in the Z direction is greater than a thickness of the circular plate portion 11 in the Z direction. As illustrated in FIG. 2, the circular plate portion 11 and the inner peripheral wall portion 14 define a recess portion 16 on the lower surface 111 side. This reduces the weight of the rotor 1.

The circular plate portion 11 is provided with three hole portions 115. The hole portions 115 are provided in such a direction that the eccentric axis C2 is eccentric with respect to the rotation axis C1, that is, in the +X direction side therefrom. Specifically, as illustrated in FIG. 1, the hole portions 115 are located only on the +X direction side with respect to a line R1 passing through the rotation axis C1 and parallel to the Y axis. Each of the hole portions 115 has a circular shape. A radial distance from the rotation axis C1 to each center of the hole portions 115 is the same. The three hole portions 115 are formed, in a range of θ1 about the rotation axis C1 as a center, on the +X direction side with respect to the line R1. θ1 is 180 degrees or less. In this way, a region in which the several hole portions 115 are formed is restrict. This suppresses degradation of strength of the circular plate portion 11 of the first member 10. Additionally, θ1, that is, the angle range of the region where the hole portions 115 are formed may be, for example, smaller than or equal to 180 degrees and greater than or equal to 90 degrees. θ1 may be smaller than or equal to 180 degrees and greater than or equal to 120 degrees.

A notch portion 15 is formed in the inner peripheral wall portion 14. The notch portion 15 is located on a side opposite to the side where the hole portions 115 are formed, with respect to the rotation axis C1 and the eccentric axis C2. As illustrated in FIG. 1, the hole portions 115 are formed symmetrically with respect to a line R2 parallel to the X axis and passing through the rotation axis C1 and the eccentric axis C2. Likewise, the notch portion 15 is formed symmetrically with respect to the line R2. Since the hole portions 115 are formed, the weight of the first member 10 is reduced on the side where the eccentric axis C2 is eccentric with respect to the rotation axis C1. In FIG. 1, the line A-A and the line R2 overlap each other.

The second member 20 is made of iron and includes an outer peripheral wall portion 24. The outer peripheral wall portion 24 has a substantially annular shape fixed to an outer peripheral surface of the inner peripheral wall portion 14 of the first member 10. In addition, a protruding portion 25 is partially provided in the outer peripheral wall portion 24. Also, a height in the Z direction of the protruding portion 25 is the same as that of the outer peripheral wall portion 24 and that of the inner peripheral wall portion 14.

The protruding portion 25 is provided at a position corresponding to the notch portion 15 of the first member 10, and protrudes through the notch portion 15 toward the rotation axis C1, that is, in the radially inward direction. As illustrated in FIG. 2, a radial thickness T25 of the protruding portion 25 is greater than a radial thickness T24 of the outer peripheral wall portion 24. In other words, the protruding amount of the protruding portion 25 in the radially inward direction is ensured to be larger than the thickness T24 of the outer peripheral wall portion 24. The protruding portion 25 is located on the side opposite to the side where the eccentric axis C2 is eccentric with respect to the rotation axis C1. Thus, the protruding portion 25 weights the second member 20 on the side opposite to the side where the eccentric axis C2 is eccentric with respect to the rotation axis C1. The protruding portion 25 is formed on the −X direction side from the line R1 in a range of θ2 about the rotation axis C1 as a center. θ2 is smaller than θ1, for example, is smaller than or equal to 90 degrees. θ2 may be smaller than or equal to 60 degrees, or 30 degrees. θ2 corresponds to a second angle range. In the present embodiment, θ2 is smaller than θ1, but is not limited to this.

The permanent magnets 30 are held in the outer peripheral wall portion 24. Specifically, holding holes for respectively holding the permanent magnets 30 are arranged beforehand in the circumferential direction in the outer peripheral wall portion 24. The permanent magnets 30 are respectively fitted into the holding holes. The outer surfaces of the permanent magnets 30 are arranged such that south poles and north poles are alternately arranged in the circumferential direction.

As described above, the hole portions 115 reduces the weight of the rotor 1 on the side where the eccentric axis C2 is eccentric with respect to the rotation axis C1, and the protruding portion 25 reduces the weight of the rotor 1 on the side opposite to the side where the eccentric axis C2 is eccentric with respect to the rotation axis C1. That is, the function as a balancer is integrated in the rotor 1 by the hole portions 115 and the protruding portion 25. Thus, as compared with a case where a balancer is separately provided from a rotor, the number of ports is reduced, the cost is reduced, the number of assembling steps is reduced, and further the increase in size is suppressed. Furthermore, since the rotor 1 is provided with the weight-reduced portion and the weighted portion, the function is fully served as a balancer.

As described above, since the first member 10 is made of aluminum and the second member 20 is made of iron, specific gravity of the first member 10 is smaller than that of the second member 20. Therefore, as compared with a rotor made entirely of iron, the rotor 1 is reduced in weight.

The specific gravity of the second member 20 is greater than that of the first member 10, and the outer peripheral wall portion 24 of the second member 20 is located on the radially outer side from the inner peripheral wall portion 14 of the first member 10. In this way, the portion having great specific gravity is positioned as far away as possible from the rotational shaft center C1, thereby ensuring the inertia force of rotation of the rotor 1. Thereby, rotation of the rotor 1 is maintained efficiently.

Herein, when the motor is driven for a long time, the rotor 1 might be heated to a high temperature, and the degree of expansion might differ between the first member 10 and the second member 20 due to a difference in linear expansion coefficient therebetween. Thus, a gap might be generated between the first member 10 and the second member 20, so that the second member 20 might be dropped from the first member 10. However, the second member 20 is fitted onto the outside of the first member 10, the first member 10 is made of aluminum, the second member 20 is made of iron, and the thermal expansion coefficient of the second member 20 is smaller than that of the first member 10. Accordingly, even if the rotor 1 is heated, the second member 20 suppresses the expansion of the first member 10, so the dropout described above does not occur.

As described above, the protruding portion 25 protrudes radially inward from the outer peripheral wall portion 24 and does not protrude radially outward. Thus, a radius from the rotation axis C1 to the outer surface of the outer peripheral wall portion 24 of the second member 20 is made substantially constant in the circumferential direction. Therefore, a distance between the outer surface of the outer peripheral wall portion 24 of the second member and the stator located outside the outer peripheral wall portion 24 is made substantially constant in the circumferential direction. This suppresses adverse effect on the magnetic force acting between the stator and the rotor 1.

While the exemplary embodiments of the present invention have been illustrated in detail, the present invention is not limited to the above-mentioned embodiments, and other embodiments, variations and variations may be made without departing from the scope of the present invention.

The rotational shaft portion 12 is formed integrally with the first member 10, but is not limited thereto. For example, the first member 10 may not be provided with the rotational shaft portion 12, but the rotational shaft portion may be formed in a support member of the motor to which the rotor 1 is assembled, and a recess portion or a hole portion roratably supported by the rotational shaft portion may be formed in the circular plate portion 11.

The first member 10 described above is made of aluminum, but may be made of synthetic resin.

In the present embodiment described above, the hole portion 115 has a circular shape, and the plural hole portions 115 are provided. However, the hole portion 115 may have a shape other than a circle shape, for example, a polygonal shape such as a triangle shape or a quadrangle shape. Further, the hole portion 115 may have an oblong shape extending in the circumferential direction.

In the present embodiment described above, the first member 10 and the second member 20 are made of different materials, but are not limited to this, and may be integrally made of the same material. In this case, for example, in consideration with the magnetic permeability of the permanent magnet 30, the first member 10 and the second member 20 may be made of, for example, iron.

What is claimed is:

1. A rotor of an inner rotor type motor comprising:
a circular plate portion rotatably supported about an axis;
an eccentric portion provided in the circular plate portion and eccentric with respect to the axis;
a peripheral wall portion extending from an outer edge of the circular plate portion; and
a permanent magnet held on the peripheral wall portion,
wherein
a circular plate portion includes a hole portion located radially outward from the eccentric portion, and
the peripheral wall portion includes a protruding portion protruding radially inward and being located in a side opposite to the hole portion with respect to the eccentric portion.

2. The rotor of the inner rotor type motor according to claim 1, wherein
the peripheral wall portion includes
an inner peripheral wall portion, and
an outer peripheral wall portion fixed to an outer peripheral surface of the inner peripheral wall portion,
specific gravity of each of the circular plate portion and the inner peripheral wall portion is smaller than specific gravity of the outer peripheral wall portion,
the inner peripheral wall portion includes a notch portion, and
the outer peripheral wall portion includes the protruding portion protruding inward from the inner peripheral wall portion through the notch portion.

3. The rotor of the inner rotor type motor according to claim 2, wherein
the circular plate portion, the eccentric portion, and the inner peripheral wall portion are made of aluminum or synthetic resin, and
the outer peripheral wall portion is made of iron.

4. The rotor of the inner rotor type motor according to claim 2, wherein the circular plate portion, the eccentric portion, and the inner peripheral wall portion are integrally formed and are made of same material.

5. The rotor of the inner rotor type motor according to claim 2, further comprising a rotational shaft portion protruding from the circular plate portion and rotatably supported about the axis,
wherein the circular plate portion, the eccentric portion, the inner peripheral wall portion, and the rotational shaft portion are integrally formed and are made of same material.
